(19) United States
(12) Patent Application Publication
(10) Pub. No.: US 2022/0020998 A1
(43) Pub. Date: Jan. 20, 2022

(54) COMPOSITIONS, ELECTRODES AND LEAD-ACID BATTERIES HAVING IMPROVED LOW-TEMPERATURE PERFORMANCE

(71) Applicant: Cabot Corporation, Boston, MA (US)

(72) Inventors: Paolina Atanassova, Munich (DE); Aurelien L. DuPasquier, Westford, MA (US); Tao Kong, Shanghai (CN)

(21) Appl. No.: 17/298,122

(22) PCT Filed: Nov. 26, 2019
(86) PCT No.: PCT/US2019/063209

§ 371 Date: May 28, 2021

Related U.S. Application Data
(60) Provisional application No. 62/774,969, filed on Dec. 4, 2018.

(51) Int. Cl. H01M 4/62; H01M 10/06

(52) U.S. Cl. CPC H01M 4/627; H01M 2004/027; H01M 4/625; H01M 10/06

(57) ABSTRACT

A composition suitable for a negative plate of lead-acid battery includes (a) a lead-based active material; (b) at least one material selected from the group consisting of a lignosulfonate and barium sulfate; and (c1) carbon black particles having a Brunauer-Emmett-Teller (BET) surface area greater than or equal to 90 m²/g and less than or equal to 900 m²/g, and an oil adsorption number (OAN) greater than or equal to 150 mL/100 g and less than or equal to 300 mL/100 g, or (c2) carbon black particles having a BET surface area greater than or equal to 40 m²/g and less than or equal to 500 m²/g, and graphenes particles. The composition has a theoretical negative active mass (NAM) BET surface area greater than or equal to 0.75 m²/g and less than or equal to 2 m²/g. The compositions can be used in electrodes, e.g., those used in lead-acid batteries.

### FIELD OF THE INVENTION

The invention relates to compositions suitable for negative plates of lead-acid batteries, related electrodes, and related lead-acid batteries having improved low-temperature performance.

### BACKGROUND

A lead-acid battery is an electrochemical storage battery typically including a positive plate, a negative plate, and an electrolyte including aqueous sulfuric acid. The plates are held in a parallel orientation and electrically isolated by porous separators to allow free movement of charged ions. The positive battery plate contains a current collector (i.e., a metal plate or grid) covered with a layer of positive, electrically conductive lead dioxide (PbO₂) on the surface. The negative battery plate contains a current collector covered with a negative, active material, which is typically lead (Pb) metal.

During discharge cycles, lead metal (Pb) supplied by the negative plate reacts with the ionized sulfuric acid electrolyte to form lead sulfate (PbSO₄) on the surface of the negative plate, while the PbO₂ located on the positive plate is converted into PbSO₄ on or near the positive plate. During charging cycles (via an electron supply from an external electrical current). PbSO₄ on the surface of the negative plate is converted back to Pb metal, and PbSO₄ on the surface of the positive plate is converted back to PbO₂. In effect, a charging cycle converts PbSO₄ into Pb metal and PbO₂; and a discharge cycle releases the stored electrical potential by converting PbO₂ and Pb metal back into PbSO₄.

Lead-acid batteries are typically produced in flooded cell and valve regulated configurations. In flooded cell batteries, the electrodes/plates are immersed in electrolyte, and gases created during charging are vented to the atmosphere. Valve regulated lead-acid (VRLA) batteries include a one-way valve that prevents external gases from entering the battery but allows internal gases, such as oxygen generated during charging, to escape if internal pressure exceeds a certain threshold. In VRLA batteries, the electrolyte is normally immobilized either by absorption of the electrolyte into a glass mat separator or by gelling the sulfuric acid with silica particles.

Currently the negative plates of lead-acid batteries are produced by applying a paste of micron-sized lead oxide (PbO₂) powder in sulfuric acid to electrically conducting lead alloy structures known as grids. Once the plates have been cured and dried, they can be assembled into a battery and charged to convert the PbO₂ to Pb sponge. In some cases, an expander mixture is added to the lead oxide/sulfuric acid paste to improve the performance of the final negative electrode. The expander mixture typically includes barium sulfate, a lignosulfonate, and carbon. The barium sulfate acts as a nucleating agent for lead sulfate produced when the plate is discharged. The lignosulfonate or other organic material increases the surface area of the active material and assists in stabilizing the physical structure of the active material. The carbon increases the electrical conductivity of the active material in the discharged state thereby improving its charge acceptance and reduces a failure mode called “negative plate sulfation” which is a term used to describe the phenomenon of kinetically irreversible formation of lead sulfate (PbSO₄) crystallites. As an additive, carbon (e.g., carbon black, graphite, activated carbon) has been proven to enable high dynamic charge acceptance and improved cycle life of both flooded cell and VRLA batteries.

### SUMMARY

in one aspect, the invention features compositions containing conductive additives (e.g., certain carbons and blends of carbon) suitable for negative plates of lead-acid batteries, related electrodes, and related lead-acid batteries having improved low-temperature performance.

As lead-acid batteries become more commonly used in new transportation applications, new requirements are placed on the batteries, and certain existing batteries are unable to meet the new requirements. For example, in the case of electric bicycles (e.g., electric motor bicycles), electric tricycles (e.g., electric rickshaws), and other low-speed electric vehicles, deep discharge cycle-life is desirable for longevity, and deep discharge capacity, particularly at low temperatures, is desirable to prevent the user from experiencing a significant loss of range in cold weather. Applicant has discovered that using certain carbon additives or blends of carbon additives in the compositions used to make the negative plates can have a beneficial effect on cycle-life and low-temperature capacity, both of which are useful in applications such as electric motor bicycles and electric rickshaws.

In another aspect, the invention features a composition suitable for a negative plate of lead-acid battery, the composition includes a lead-based active material; at least one material selected from the group consisting of a lignosulfonate and barium sulfate; and carbon black particles having a Brunauer-Emmett-Teller (BET) surface area greater than or equal to 90 m²/g and less than or equal to 900 m²/g, and an oil adsorption number (OAN) greater than or equal to 150 mL/100 g and less than or equal to 300 mL/100 g, wherein the composition has a theoretical negative active mass (NAM) BET surface area greater than or equal to 0.75 m²/g and less than or equal to 2 m²/g.

Embodiments may include one or more of the following features. The carbon black particles have an OAN greater than or equal to 170 mL/100 g and less than or equal to 250 mL/100 g. The composition has a theoretical NAM BET surface area greater than or equal to 0.75 m²/g and less than or equal to 1 m²/g. The composition includes greater than or equal to 0.1 wt % and less than or equal to 0.5 wt % of the lignosulfonate. The ratio of the theoretical NAM BET surface area to the concentration of the lignosulfonate ((m²/g)/wt %) is greater than or equal to 2 and less than or equal to 4. The composition includes greater than or equal to 0.7 wt % and less than or equal to 1.2 wt % of the barium sulfate. The composition includes greater than or equal to 0.1 wt % and less than or equal to 1 wt % of the carbon black particles. The carbon black particles have not undergone a heat treatment. The carbon black particles have surface energy ranging from 10 to 30 mJ/m². The carbon black particles have a Lₐ crystallite size ranging from 10 to 25 Angstroms. The carbon black particles have a L_{c} crystallite size ranging from 10 to 20 Angstroms. The carbon black particles have % crystallinity (I_{G}/(I_{G}+I_{D}))×100%) ranging from 20 to 35%. The carbon black particles have a statistical thickness surface area ranging from 80 to 180 m²/g.

In another aspect, the invention features a composition suitable for a negative plate of lead-acid battery, the composition including a lead-based active material; at least one material selected from the group consisting of a lignosulfonate and barium sulfate; carbon black particles having a Brunauer-Emmett-Teller (BET) surface area greater than or equal to 40 m²/g and less than or equal to 500 m²/g; and graphenes particles, wherein the composition has a theoretical negative active mass (NAM) BET surface area greater than or equal to 0.75 m²/g and less than or equal to 2 m²/g.

Embodiments may include one or more of the following features. The carbon black particles have an OAN greater than or equal to 75 mL/100 g and less than or equal to 300 mL/100 g. The composition has a theoretical NAM BET surface area greater than or equal to 0.75 m²/g and less than or equal to 1 m²/g. The composition includes greater than or equal to 0.1 wt % and less than or equal to 0.5 wt % of the lignosulfonate. The ratio of the theoretical NAM BET surface area to the concentration of the lignosulfonate ((m²/g)/wt %) is greater than or equal to 2 and less than or equal to 4. The composition includes greater than or equal to 0.7 wt % and less than or equal to 1.2 wt % of the barium sulfate. The composition includes greater than or equal to 0.1 wt % and less than or equal to 1 wt % of the carbon black particles. The carbon black particles and the graphenes particles have a weighted average BET surface area greater than or equal to 90 m²/g and less than or equal to 500 m²/g. The graphenes particles have a BET surface area greater than or equal to 100 m²/g and less than or equal to 500 m²/g. The ratio of the concentrations of the graphenes particles to carbon black particles range from 0.25:1 to 1.5:1. The total concentration of the carbon black particles and the graphenes particles is greater than or equal to 0.25 wt % and less than or equal to 1 wt %. The carbon black particles have not undergone a heat treatment. The carbon black particles have surface energy ranging from 10 to 30 mJ/m′. The carbon black particles have a Lₐ crystallite size ranging from 10 to 25 Angstroms. The carbon black particles have a L_{c} crystallite size ranging from 10 to 20 Angstroms. The carbon black particles have % crystallinity (I_{G}/(I_{G}+I_{D}))×100%) ranging from 20 to 35%. The carbon black particles have a statistical thickness surface area ranging from 80 to 180 m²/g.

In another aspect, the invention features electrodes including the compositions described herein.

In another aspect, the invention features lead-acid batteries including the electrodes described herein.

Unless expressly indicated otherwise, all percentages herein are weight percentages. All ranges include their end points unless expressly indicated otherwise.

Other aspects, features, and advantages of the invention will be apparent from the description of the embodiments thereof and from the claims.

### BRIEF DESCRIPTION OF THE DRAWINGS

FIG. 1 is a plot showing the ambient-temperature (20° C.), two-hour capacity of 20-Ah flooded lead-acid single cells containing selected carbon additives in negative active masses (NAMs).

FIG. 2 shows plots of ambient-temperature (20° C.) large current capacity and charge acceptance of 20-Ah flooded lead-acid single cells containing selected carbon additives in NAMs.

FIG. 3 shows plots of low temperature (−15° C. and −20° C.) two-hour rate capacity of 20-Ah flooded lead-acid single cells containing selected carbon additives in NAMs.

FIG. 4 is a plot of low temperature (−15° C. and −20° C.) two-hour rate capacity of 20-Ah flooded lead-acid single cells containing selected carbon additives in NAMs vs (NAM BET surface area/wt. % lignosulfonate) ratio.

FIG. 5 is a plot of cycle-life (100% depth-of-discharge (DOD), C/2, 20° C.) of 20-Ah flooded lead-acid single cells containing selected carbon additives in NAMs,

### DETAILED DESCRIPTION OF THE EMBODIMENTS

Described herein are compositions (e.g., NAMs) that can be used to produce electrodes for batteries (e.g., lead-acid batteries), methods of making the compositions, and applications of the compositions in electrodes (e.g., negative plates) and batteries.

In some embodiments, the electrode compositions include one or more (a) lead-based active material, (b) barium sulfate, (c) lignosulfonate as an expander, and (d) conductive additives. As described herein, the conductive additives can include (1) certain carbon black particles or (2) a blend of certain carbon black particles and graphenes particles. Both conductive additives are capable of enhancing the low-temperature performance of electrodes and lead-acid batteries that include the compositions.

Carbon Black Particles

In certain embodiments, the carbon black particles are characterized by their surface areas and oil adsorption numbers (i.e., structure). The carbon black particles can have a relatively wide range of total surface areas. Without being bound by theory, it is believed that, carbons with medium surface areas can minimize lignosuifonates adsorption and preserve electrode porosity, both of which are favorable for low temperature performance. In some embodiments, the carbon black particles have a Brunauer-Emmett-Teller (BET) surface area greater than or equal to 90 m²/g, or less than or equal to 900 m²/g, for example, ranging from 90 to 900 m²/g. The BET surface area can have or include, for example, one of the following ranges: from 90 to 800 m²/g, or from 90 to 700 m²/g, or from 90 to 600 m²/g, or from 90 to 500 m²/g, or from 90 to 400 m²/g, or from 90 to 300 m²/g, or from 90 to 200 m²/g, or from 200 to 900 m²/g, or from 200 to 800 m²/g, or from 200 to 700 m²/g, or from 200 to 600 m²/g, or from 200 to 500 m²/g, or from 200 to 400 m²/g, or from 200 to 300 m²/g, or from 300 to 900 m²/g, or from 300 to 800 m²/g, or from 300 to 700 m²/g, or from 300 to 600 m²/g, or from 300 to 500 m²/g, or from 300 to 400 m²/g, or from 400 to 900 m²/g, or from 400 to 800 m²/g, or from 400 to 700 m²/g, or from 400 to 600 m²/g, or from 400 to 500 m²/g, or from 500 to 900 m²/g, or from 500 to 800 m²/g, or from 500 to 700 m²/g, or from 500 to 600 m²/g, or from 600 to 900 m²/g, or from 600 to 800 m²/g, or from 600 to 700 m²/g, or from 700 to 900 m²/g, or from 700 to 800 m²/g, or from 800 to 900 m²/g. The BET surface area can have or include, for example, one of the following ranges: greater than or equal to 200 m²/g, or greater than or equal to 250 m²/g, or greater than or equal to 300 m²/g, or greater than or equal to 350 m²/g, or greater than or equal to 400 m²/g, or greater than or equal to 450 m²/g, or greater than or equal to 500 m²/g, or greater than or equal to 550 m²/g, or greater than or equal to 600 m²/g, or greater than or equal to 650 m²/g, or greater than or equal to 700 m²/g, or greater than or equal to 750 m²/g, or greater than or equal to 800 m²/g, or less than or equal to 850 m²/g, or less than or equal to 800 m²/g, or less than or equal to 750 m²/g, or less than or equal to 700 m²/g, or less than or equal to 650 m²/g, or less than or equal to 600 m²/g, or less than or equal to 550 m²/g, or less than or equal to 500 m²/g, or less than or equal to 450 m²/g, or less than or equal to 400 m²/g, or less than or equal to 350 m²/g, or less than or equal to 300 m²/g, or less than or equal to 250 m²/g. Other ranges within these ranges are possible. All BET surface area values disclosed herein refer to BET nitrogen surface area and are determined by ASTM D6556-10, the entirety of which is incorporated herein by reference.

As with the BET surface areas, the carbon black particles can have a range of oil absorption numbers (OANs), which are indicative of the particles' structures, or volume-occupying properties. For a given mass, high structure carbon black particles can occupy more volume than other carbon black particles having lower structures. When used as a conductive additive in a battery electrode, carbon black particles having relatively high OANs can provide a continuously electrically-conductive network (i.e., percolate) throughout the electrode at relatively lower loadings. Consequently, more electroactive material can be used, thereby improving the performance of the battery. In some embodiments, the carbon black particles have OANs greater than or equal to 150 mL/100 g, or less than or equal to 300 mL/100 g, for example, ranging from 150 to 300 mL/100 g. The OANs can have or include, for example, one of the following ranges: from 150 to 270 mL/100 g, or from 150 to 250 mL/100 g, or from 150 to 230 mL/100 g, or from 150 to 210 mL/100 g, or from 1.50 to 190 mL/100 g, or from 150 to 170 mL/100 g, or from 170 to 300 mL/100 g, or from 170 to 270 mL/100 g, or from 170 to 250 mL/100 g, or from 170 to 230 mL/100 g, or from 170 to 210 mL/100 g, or from 170 to 190 mL/100 g, or from 190 to 300 mL/100 g, or from 190 to 270 mL/100 g, or from 190 to 250 mL/100 g, or from 190 to 230 mL/100 g, or from 190 to 210 mL/100 g, or from 210 to 300 mL/100 g, or from 210 to 270 mL/100 g, or from 210 to 250 mL/100 g, or from 210 to 230 mL/100 g, or from 230 to 300 mL/100 g, or from 230 to 270 mL/100 g, or from 230 to 250 mL/100 g, or from 250 to 300 mL/100 g, or from 250 to 270 mL/100 g, or from 2710 to 300 mL/100 g. The OAN can have or include, for example, one of the following ranges: greater than or equal to 170 mL/100 g, or greater than or equal to 190 mL/100 g, or greater than or equal to 210 mL/100 g, or greater than or equal to 230 mL/100 g, or greater than or equal to 250 mL/100 g, or greater than or equal to 270 mL/100 g, or less than or equal to 270 mL/100 g, or less than or equal to 250 mL/100 g, or less than or equal to 230 mL/100 g, or less than or equal to 210 mL/100 g, or less than or equal to 190 mL/100 g, or less than or equal to 170 mL/100 g. Other ranges within these ranges are possible. All OAN values cited herein are determined by the method described in ASTM D 2414-16.

In addition to the BET and OAN properties described above, the carbon black particles can further have one or more (e.g., at least one, two, three, four, five, six or more) of the following additional properties described below, in any combination: statistical thickness surface area (STSA), surface energy, crystallinity characteristics (as indicated by Lₐ and/or L_{c} Raman microcrystalline planar sizes and/or crystallinities), and NAM BET surface area, in any combination.

As with the BET surface areas, the carbon black particles can have a range of statistical thickness surface areas (STSAs), with the difference, if any, between BET surface area and STSA being indicative of the porosity of the particles. In some embodiments, the carbon black particles have STSAs greater than or equal to 80 m²/g, or less than or equal to 180 m²/g, for example, ranging from 80 to 180 m²/g. The STSAs can have or include, for example, one of the following ranges: greater than or equal to 100 m²/g, or greater than or equal to 120 m²/g, or greater than or equal to 140 m²/g, or greater than or equal to 160 m²/g, or less than or equal to 160 m²/g, or less than or equal to 140 m²/g, or less than or equal to 120 m²/g, or less than or equal to 100 m²/g. The STSAs can have or include, for example, one of the following ranges: from 80 to 160 m²/g, or from 80 to 140 m²/g, or from 80 to 120 m²/g, or from 80 to 100 m²/g, or from 100 to 180 m²/g, or from 100 to 160 m²/g, or from 100 to 140 m²/g, or from 100 to 120 m²/g, or from 120 to 180 m²/g, or from 120 to 160 m²/g, or from 120 to 140 m²/g or from 140 to 180 m²/g, or from 140 to 160 m²/g, or from 160 to 180 m²/g. Other ranges within these ranges are possible. Statistical thickness surface area as disclosed herein is determined by ASTM D6556-10 to the extent that such determination is reasonably possible.

In some embodiments, the carbon black particles have a surface energy (SE or SEP) greater or equal to 10 mJ/m², or less than or equal to 30 mJ/m², e.g., ranging from 10 to 30 mJ/m². The surface energy can have or include, for example, one of the following ranges: from 10 to 26 m²/g, or from 10 to 22 m²/g, or from 10 to 18 m²/g, or from 10 to 14 m²/g, or from 14 to 30 m²/g, or from 14 to 26 m²/g, or from 14 to 22 m²/g, or from 14 to 18 m²/g, or from 18 to 30 m²/g, or from 18 to 26 m²/g, or from 18 to 22 m²/g, or from 22 to 30 m²/g, or from 22 to 26 m²/g, or from 26 to 30 m²/g. In certain embodiments, the surface energy, as measured by DWS, is less than or equal to 30 mJ/m², or less than or equal to 26 mJ/m², or less than or equal to 22 mJ/m², or less than or equal to 18 mJ/m², or less than or equal to 14 mJ/m², or greater than or equal 14 m²/g, or greater than or equal 18 m²/g, or greater than or equal 22 m²/g, or greater than or equal 26 m²/g. Other ranges within these ranges are possible.

Surface energy as disclosed herein can be measured by Dynamic Vapor (Water) Sorption (DVS) or water spreading pressure. Water spreading pressure is a measure of the interaction energy between the surface of carbon black (which absorbs no water) and water vapor. The spreading pressure is measured by observing the mass increase of a sample as it adsorbs water from a controlled atmosphere. In the test, the relative humidity (RH) of the atmosphere around the sample is increased from 0% (pure nitrogen) to about 100% (water-saturated nitrogen). If the sample and atmosphere are always in equilibrium, the water spreading pressure (πₑ) of the sample is defined as:

$${π}_{e} = \frac{R T}{A} {\int }_{O}^{{P}_{o}} Γd ln P$$

where R is the gas constant, T is the temperature, A is the BET surface area of the sample as described herein, Γ is the amount of adsorbed water on the sample (converted to moles/gm), P is the partial pressure of water in the atmosphere, and Pₒ is the saturation vapor pressure in the atmosphere. In practice, the equilibrium adsorption of water on the surface is measured at one or (preferably) several discrete partial pressures and the integral is estimated by the area under the curve.

The procedure for measuring the water spreading pressure is detailed in “Dynamic Vapor Sorption Using Water, Standard Operating Procedure”, rev. Feb. 8, 2005 (incorporated in its entirety by reference herein), and is summarized here. Before analysis, 100 mg of the carbon black to be analyzed was dried in an oven at 125° C. for 30 minutes. After ensuring that the incubator in the Surface Measurement Systems DVS1 instrument (supplied by SMS Instruments, Monarch Beach. Calif.) had been stable at 25° C. for 2 hours, sample cups were loaded in both the sample and reference chambers. The target RH was set to 0% for 10 minutes to dry the cups and to establish a stable mass baseline. After discharging static and taring the balance, approximately 10-12 mg of carbon black was added to the cup in the sample chamber. After sealing the sample chamber, the sample was allowed to equilibrate at 0% RI-1. After equilibration, the initial mass of the sample was recorded. The relative humidity of the nitrogen atmosphere was then increased sequentially to levels of approximately 0, 5, 10, 20, 30, 40, 50, 60, 70, 80, 90, and 95% RH, with the system allowed to equilibrate for 20 minutes at each RH level. The mass of water adsorbed at each humidity level was recorded, from which water spreading pressure was calculated (see above). The measurement was done twice on two separate samples and the average value is reported.

Alternatively or additionally to having the surface energies described herein, in certain embodiments, the carbon black particles have a crystallite size that indicates a relatively low to moderate degree of graphitization. A higher degree of graphitization correlates with certain crystalline domains as shown by higher Lₐ crystallite size values, as determined by Raman spectroscopy, where Lₐ is defined as 43.5× (area of G band/area of D band). Raman measurements of Lₐ were based on Gruber et al, “Raman studies of heat-treated carbon blacks,” Carbon Vol. 32 (7), pp. 1377-1382, 1994, which is incorporated herein by reference. The Raman spectrum of carbon includes two major “resonance” bands or peaks at about 1340 cm⁻¹ and 1580 cm⁻¹, denoted as the “D” and “G” bands, respectively. It is generally considered that the D band is attributed to disordered sp² carbon, and the G band to graphitic or “ordered’ sp¹ carbon. Using an empirical approach, the ratio of the G/D bands and an Lₐ measured by X-ray diffraction (XRD) are highly correlated, and regression analysis gives the empirical relationship:

Lₐ=43.5×(area of G band/area of D band),

in which Lₐ is calculated in Angstroms. Thus, a higher Lₐ value corresponds to a more ordered crystalline structure.

In some embodiments, the carbon black particles have an Lₐ crystallite size of greater than or equal to 10 Λ, or less than or equal to 25 Å, for example, from 10 Å to 25 Å. The Lₐ crystallite size can have or include, for example, one of the following ranges: from 10 Å to 22 Å, or from 10 Å to 19 Å, or from 10 Å to 16 Å, or from 10 Å to 13 Å, or from 13 Å to 25 Å, or from 13 Å to 22 Å, or from 13 Å to 19 Å, or from 13 Å to 16 Å, or from 16 Å to 25 Å, or from 16 Å to 22 Å, or from 16 Å to 19 Å, or from 19 Å to 25 Å, or from 19 Å to 22 Å, or from 22 Å to 25 Å. In some embodiments, the Lₐ crystallite size is greater than or equal to 13 Å, or greater than or equal to 16 Å, or greater than or equal to 19 Å, or greater than or equal to 22 Å, or less than or equal to 22 Å, or less than or equal to 19 Å, or less than or equal to 16 Å, or less than or equal to 13 Å.

The crystalline domains can be further characterized by an L_{c} crystallite size. The L_{c} crystallite size was determined by X-ray diffraction using an X-ray diffractometer (PANalytical X'Pert Pro, PANalytical B.V.), with a copper tube, tube voltage of 45 kV, and a tube current of 40 mA. A sample of carbon black particles was packed into a sample holder (an accessory of the diffractometer), and measurement was performed over angle (2θ) range of 10° to 80°, at a speed of 0.14°/min. Peak positions and full width at half maximum values were calculated by means of the software of the diffractometer. For measuring-angle calibration, lanthanum hexaboride (LaB₆) was used as an X-ray standard. From the measurements obtained, the L_{c} crystallite size was determined using the Scherrer equation: L_{c} (Å)=K*λ/(β*cos θ), where K is the shape factor constant (0.9); λ, is the wavelength of the characteristic X-ray line of Cu K_{α1} (1.54056 Å); β is the peak width at half maximum in radians; and θ is determined by taking half of the measuring angle peak position (2θ).

A higher L_{c} value corresponds to a more ordered crystalline structure. In some embodiments, the carbon black particles have an L_{c} crystallite size of less than or equal 20 Å, or greater than or equal to 10 Å, for example, from 10 Å to 20 Å. The L_{c} crystallite size can have or include, for example, one of the following ranges: from 10 Å to 18 Å, or from 10 Å to 16 Å, or from 10 Å to 14 Å, or from 10 Å to 12 Å, or from 12 Å to 20 Å, or from 12 Å to 18 Å, or from 12 Å to 16 Å, or from 12 Å to 14 Å, or from 14 Å to 20 Å, or from 14 Å to 18 Å, or from 14 Å to 16 Å, or from 16 Å to 20 Å, or from 16 Å to 18 Å, or from 18 Å to 20 Å. In some embodiments, the L_{c} crystallite size is greater than or equal to 12 Å, or greater than or equal to 14 Å, or greater than or equal to 16 Å, or greater than or equal to 18 Å, or less than or equal to 18 Å, or less than or equal to 16 Å, or less than or equal to 14 Å, or less than or equal to 12 Å.

In various embodiments, the carbon black particles have a moderate degree of graphitization, as indicated by a high % crystallinity, which is obtained from Raman measurements as a ratio of the area of the G band and the areas of G and D bands (I_{G}/(I_{G}+I_{D})). The % crystallinity can be achieved by using certain heat treatment temperatures and times, and in some embodiments, a longer heat treatment time (described below) can provide relatively high % crystallinity. In certain embodiments, the carbon black particles have % crystallinities ((I_{G}/(I_{G}+I_{D}))×100%) ranging from 20% to 35%, as determined by Raman spectroscopy. The % crystallinity ((I_{G}/(I_{G}+I_{D}))×100%) can have or include, for example, one of the following, ranges: from 20% to 32%, or from 20% to 29%, or from 20% to 26%, or from 20% to 23%, or from 23% to 35%, or from 23% to 32%, or from 23% to 29%, or from 23% to 26%, or from 26% to 35%, or from 26% to 32%, or from 26% to 29%, or from 23% to 35%, or from 23% to 32%, or from 26% to 35%, or from 26% to 32%, or from 26% to 29%, or from 29% to 35%, or from 29% to 32%, or from 29% to 35%, or from 32% to 35%. The % crystallinity ((I_{G}(I_{G}+I_{D}))×100%) can have or include, for example, one of the following ranges: greater than 20%, or greater than 23%, or greater than 26%, or greater than 29%, or greater than 32%, or less than 35%, or less than 32%, or less than 29%, or less than 26%, or less than 23%. Raman measurements were made using a Horiha LabRAM Aramis Raman microscope and the accompanying LabSpec6 software.

In various embodiments, the carbon black particles are not heat-treated carbon black particles. “Heat-treated carbon black particles” are carbon black particles that have undergone a “heat treatment,” which as used herein, generally refers to a post-treatment of base carbon black particles that had been previously formed, e.g., by a furnace black process. The heat treatment can occur under inert conditions (i.e., in an atmosphere substantially devoid of oxygen), and typically occurs in a vessel other than that in which the base carbon black particles were formed. Inert conditions include, but are not limited to, a vacuum, and an atmosphere of inert gas, such as nitrogen, argon, and the like. In some embodiments, the heat treatment of carbon black particles under inert conditions is capable of reducing the number of impurities (e.g., residual oil and salts), defects, dislocations, and/or discontinuities in carbon black crystallites and/or increasing the degree of graphitization.

The heat treatment temperatures can vary. In various embodiments, the heat treatment (e.g., under inert conditions) is performed at a temperature of at least 1000° C., or at least 1200° C., or at least 1400° C., or at least 1500° C., or at least 1700° C., or at least 2.000° C. In some embodiments, the heat treatment is performed at a temperature ranging from 1000° C. to 2500° C., e.g., from 1400° C. to 1600° C. Heat treatment performed at a temperature refers to one or more temperature ranges disclosed herein, and can involve heating at a steady temperature, or heating while ramping the temperature up or down, either stepwise and/or otherwise.

The heat treatment time periods can vary. In certain embodiments, the heat treatment is performed for at least 15 minutes, e.g., at least 30 minutes, or at least 1 hour, or at least 2 hours, or at least 6 hours, or at least 24 hours, or any of these time periods up to 48 hours, at one or more of the temperature ranges disclosed herein. In some embodiments, the heat treatment is performed for a time period ranging from 15 minutes to at least hours, e.g., from 15 minutes to 6 hours, or from 15 minutes to 4 hours, or from 30 minutes to 6 hours, or from 30 minutes to 4 hours.

The carbon black particles can also be commercially-available particles. Examples of carbon black particles include PBX® 22, PBX® 16, PBX® 55, PBX® 135, and PBX® 09 carbon black particles, available from Cabot Corporation.

Blends of Carbon Black Particles and Graphenes Particles

In other embodiments, rather than using the carbon black particles described above, other carbon black particles are used in combination with graphenes particles to form a blend of conductive additives. These other carbon black particles are characterized by different properties: surface areas; oil adsorption numbers; and one or more of the properties described below. The properties are determined in accordance with the methods described above. The carbon black particles can have a relatively low total surface area. Without being bound by theory, it is believed that, carbons with low surface areas can minimize lignosulfonates adsorption and preserve electrode porosity, both of which are favorable for low temperature performance. In some embodiments, the carbon black particles have a Brunauer-Emmett-Teller (BET) surface area greater than or equal to 40 m²/g, or less than or equal to 500 m²/g, for example, ranging from 40 to 500 m₂/g. The BET surface area can have or include, for example, one of the following ranges: from 40 to 450 m²/g, or from 40 to 400 m²/g, or from 40 to 350 m²/g, or from 40 to 300 m²/g, or from 40 to 250 m²/g, or from 40 to 200 m² g, or from 40 to 150 m²/g, or from 40 to 100 m²/g, or from 100 to 500 m²/g, or from 100 to 450 m²/g, or from 100 to 400 m²/g, or from 100 to 350 m²/g, or from 100 to 300 m²/g, or from 100 to 250 m²/g, or from 100 to 200 m²/g, or from 100 to 150 m²/g, or from 150 to 500 m²/g, or from 150 to 450 m²/g, or from 150 to 400 m²/g, or from 150 to 350 m²/g, or from 150 to 300 m²/g, or from 150 to 250 m²/g, or from 150 to 200 m²/g, or from 200 to 500 m²/g, or from 200 to 450 m²/g, or from 200 to 400 m²/g, or from 200 to 350 m²/g, or from 200 to 300 m²/g, or from 200 to 250 m²/g, or from 250 to 500 m²/g, or from 250 to 450 m²/g, or from 250 to 400 m²/g, or from 250 to 350 m²/g, or from 250 to 300 m²/g, or from 300 to 500 m²/g, or from 300 to 450 m²/g, or from 300 to 400 m²/g, or from 300 to 350 m²/g, or from 350 to 500 m²/g, or from 350 to 450 m²/g, or from 350 to 400 m²/g, or from 400 to 500 m²/g, or from 400 to 450 m²/g, or from 450 to 500 m²/g. The BET surface area can have or include, for example, one of the following ranges: greater than or equal to 100 m²/g, or greater than or equal to 150 m²/g, or greater than or equal to 200 m²/g, or greater than or equal to 250 m²/g, or greater than or equal to 300 m²/g, or greater than or equal to 350 m²/g, or greater than or equal to 400 m²/g, or greater than or equal to 450 m²/g, or less than or equal to 450 m²/g, or less than or equal to 400 m²/g, or less than or equal to 350 m²/g, or less than or equal to 300 m²/g, or less than or equal to 250 m²/g, or less than or equal to 200 m²/g, or less than or equal to 150 m²/g or less than or equal to 100 m²/g. Other ranges within these ranges are possible.

In some embodiments, the carbon black particles have OANs greater than or equal to 75 mL/100a, or less than or equal to 300 mL/100 g. for example, ranging from 75 to 300 mL/100 g. The OANs can have or include, for example, one of the following ranges: from 75 to 275 mL/100 g, or from 75 to 250 mL/100 g, or from 75 to 225 mL/100 g, or from 75 to 200 mL/100 g, or from 75 to 175 mL/100 g, or from 75 to 150 mL/100 g, or from 75 to 125 mL/100 g, or from 75 to 100 mL/100 g, or from 100 to 300 mL/100 g, or from 100 to 275 mL/100 g or from 100 to 250 mL/100 g, or from 100 to 225 mL/100 g, or from 100 to 200 mL/100 g, or from 100 to 175 mL/100 g, or from 100 to 150 mL/100a, or from 100 to 125 mL/g, or from 125 to 300 mL/100 g, or from 125 to 275 mL/100 g, or from 125 to 250 mL/100 g, or from 125 to 225 mL/100 g, or from 125 to 200 mL/100 g, or from 125 to 175 mL/100 g, or from 125 to 150 mL/100 g or from 150 to 300 mL/100 g, or from 150 to 275 mL/100 g, or from 150 to 250 mL/100 g, or from 150 to 225 mL/100 g, or from 150 to 200 mL/100 g, or from 150 to 175 mL/100 g, or from 175 to 300 mL/100 g, or from 175 to 275 mL/100 g, or from 175 to 250 mL/100 g, or from 175 to 225 mL/100 g, or from 175 to 200 mL/100 g, or from 200 to 300 mL/100 g, or from 200 to 275 mL/100a, or from 200 to 250 mL/100 g, or from 200 to 225 mL/100 g, or from 225 to 300 mL/100a, or from 225 to 275 mL/100 g, or from 225 to 250 mL/100 g, or from 250 to 300 mL/100 g, or from 250 to 275 mL/100 g, or from 275 to 300 mL/100 g. The OAN can have or include, for example, one of the following ranges: greater than or equal to 75 mL/100 g, or greater than or equal to 100 mL/100 g, or greater than or equal to 125 mL/100 g, or greater than or equal to 150 mL/100 g, or greater than or equal to 175 mL/100 g, or greater than or equal to 200 mL/100 g, or greater than or equal to 225 mL/100 g, or greater than or equal to 250 mL/100 g, or greater than or equal to 275 mL/100 g, or less than or equal to 275 mL/100 g, or less than or equal to 250 mL/100 g, or less than or equal to 225 mL/100 g, or less than or equal to 200 mL/100 g, or less than or equal to 175 mL/100 g, or less than or equal to 150 mL/100 g, or less than or equal to 125 mL/100 g, or less than or equal to 100 mL/100 g. Other ranges within these ranges are possible.

In some embodiments, the carbon black particles have STSAs greater than or equal to 50 m²/g, or less than or equal to 500 m²/g, for example, ranging from 50 to 500 m²/g. The STSAs can have or include, for example, one of the following ranges: greater than or equal to 100 m²/g, or greater than or equal to 150 m²/g, or greater than or equal to 200 m²/g, or greater than or equal to 250 m²/g, or greater than or equal to 300 m²/g, or greater than or equal to 350 m²/g, or greater than or equal to 400 m²/g, or greater than or equal to 450 m²/g, or less than or equal to 450 m²/g, or less than or equal to 400 m²/g, or less than or equal to 350 m²/g, or less than or equal to 300 m²/g, or less than or equal to 250 m²/g, or less than or equal to 200 m²/g, or less than or equal to 150 m²/g, or less than or equal to 100 m²/g. The STSAs can have or include, for example, one of the following ranges: from 50 to 400 m²/g, or from 50 to 300 m²/g, or from 50 to 200 m²/g, or from 100 to 500 m²/g, or from 100 to 400 m²/g, or from 100 to 300 m²/g, or from 100 to 200 m²/g, or from 200 to 500 m²/g, or from 200 to 400 m²/g, or from 200 to 300 m²/g, or from 300 to 500 m²/g, or from 300 to 400 m²/g, or from 400 to 500 m²/g. Other ranges within these ranges are possible. Statistical thickness surface area is determined by ASTM D6556-10 to the extent that such determination is reasonably possible.

In some embodiments, the carbon black particles have a surface energy (SE or SEP) greater or equal to 20 mJ/m², or less than or equal to 30 mJ/m², e.g., ranging from 20 to 30 mJ/m². The surface energy can have or include, for example, one of the following ranges: from 20 to 28 m²/g, or from 20 to 26 m²/g, or from 20 to 24 m²/g, or from 20 to 22 m²/g, or from 22 to 30 m²/g, or from 22 to 28 m²/g, or from 22 to 26 m²/g, or from 22 to 24 m²/g, or from 24 to 30 m²/g, or from 24 to 28 m²/g, or from 24 to 26 m²/g, or from 26 to 30 m²/g, or from 26 to 28 m²/g, or from 28 to 30 m²/g. In certain embodiments, the surface energy, as measured by DWS, is less than or equal to 28 mJ/m², or less than or equal to 26 mJ/m², or less than or equal to 24 mJ/m², or less than or equal to 22 mJ/m², or greater than or equal 22 m²/g, or greater than or equal 24 m²/g, or greater than or equal 26 m²/g, or greater than or equal 28 m²/g. Other ranges within these ranges are possible.

In some embodiments, the carbon black particles have an Lₐ crystallite size of greater than or equal to 10 Å, or less than or equal to 25 Å, for example, from 10 Å to 25 Å. The Lₐ crystallite size can have or include, for example, one of the following ranges: from 10 Å to 22 Å, or from 10 Å to 19 Å, or from 10 Å to 16 Å, or from 10 Å to 13 Å, or from 13 Å to 25 Å, or from 13 Å to 22 Å, or from 13 Å to 19 Å, or from 13 Å to 16 Å, or from 16 Å to 25 Å, r from 16 Å to 22 Å, or from 16 Å to A, or from 19 Å to 25 Å, or from 19 Å to 22 Å, or from 22 Å to 25 Å. In some embodiments, the Lₐ crystallite size is greater than or equal to 13 Å, or greater than or equal to 16 Å, or greater than or equal to 19 Å, or greater than or equal to 22 Å, or less than or equal to 22 Å, or less than or equal to 19 Å, or less than or equal to 16 Å, or less than or equal to 13 Å.

In some embodiments, the carbon black particles have an L_{c} crystallite size of less than or equal 20 Å, or greater than or equal to 10 Å, for example, from 10 Å to 20 Å. [The L_{c} crystallite size can have or include, for example, one of the following ranges: from 10 Å to 18 Å, or from 10 Å to 1.6 Å, or from 10 Å to 14 Å, or from 10 Å to 12 Å, or from 12 Å to 20 Å, or from 12 Å to 18 Å, or from 12 Å to 16 Å, or from 12 Å to 14 Å, or from 14 Å to 20 Å, or from 14 Å to 18 Å, or from 14 Å to 16 Å, or from 16 Å to 20 Å, or from 16 Å to 18 Å, or from 18 Å to 20 Å. In some embodiments, the L_{c} crystallite size is greater than or equal to 12 Å, or greater than or equal to 14 Å, or greater than or equal to 16 Å, or greater than or equal to 18 Å, or less than or equal to 18 Å, or less than or equal to 16 Å, or less than or equal to 14 Å, or less than or equal to 12 Å.

In certain embodiments, the carbon black particles have % crystallinities ((I_{G}/(I_{G}+I_{D}))×100%) ranging from 20% to 35%, as determined by Raman spectroscopy. The % crystallinity ((I_{G}/(I_{G}+I_{D}))×100%) can have or include, for example, one of the following ranges: from 20% to 32%, or from 20% to 29%, or from 20% to 26%, or from 20% to 23%, or from 23% to 35%, or from 23% to 32%, or from 23% to 29%, or from 23% to 26%, or from 26% to 35%, or from 26% to 32%, or from 26% to 29%, or from 23% to 35%, or from 23% to 32%, or from 26% to 35%, or from 26% to 32%, or from 26% to 29%, or from 29% to 35%, or from 29% to 32%, or from 29% to 35%, or from 32% to 35%. The % crystallinity ((I_{G}/(I_{G}+I_{D}))×100%) can have or include, for example, one of the following ranges: greater than 20%, or greater than 23%, or greater than 26%, or greater than 29%, or greater than 32%, or less than 35%, or less than 32%, or less than 29%, or less than 26%, or less than 23%.

The carbon black particles can also be commercially-available particles. Examples of carbon black particles include PBX® 4, PBX® 7, PBX® 22, and PBX® 16 carbon black particles, available from Cabot Corporation.

The graphenes particles or “graphenes” as used herein are carbonaceous material that include at least one single-atom thick sheet of sp²-hybridized carbon atoms bonded to each other to form a honey-comb lattice. Graphenes can include single layer graphenes, few layer graphenes, and/or graphene aggregates. In certain embodiments, the graphenes comprise few-layer graphenes (FLGs) having two or more stacked graphene sheets, e.g., a 2-50 layer graphenes, or 20-50 layer graphenes. In some embodiments, the graphenes include single-layer graphene and/or 2-20 layer graphenes (or other ranges disclosed herein). In other embodiments, the graphenes include 3-15 layer graphenes. The number of layers is estimated from its known relationship to BET surface area of graphene sheets.

The dimensions of graphenes are typically defined by thickness and lateral domain size. Graphene thickness generally depends on the number of layered graphene sheets. The dimension transverse to the thickness is referred to herein as the “lateral” dimension. In various embodiments, the graphenes have a lateral size ranging from 10 nm to 10 μm, e.g., from 10 nm to 5 μm, or from 10 nm to 2 μm, or from 100 nm to 10 μm, or from 100 nm to 5 μm, or from 100 nm to 2 μm, or from 0.5 μm to 10 μm, or from 0.5 μm to 5 μm, or from 0.5 μm to 2 μm, or from 1 μm to 10 μm, or from 1 μm to 5 μm, or from 1 μm to 2 μm.

The graphenes can exist as discrete particles and/or as aggregates. “Aggregates” refers to a plurality of graphene particles (platelets) comprising few layer graphenes that are adhered to each other. For graphene aggregates, “lateral domain size” refers to the longest indivisible dimension of the aggregate. Thickness of the aggregates is defined as the thickness of the individual graphene particle. Graphene aggregates can be generated mechanically, e.g., by exfoliation of graphite.

In some embodiment, the surface area of the graphenes is a function of the number of sheets stacked upon each other and can be calculated based on the number of layers. In certain embodiments, the graphenes have no microporosity. For example, the surface area of a graphene monolayer with no porosity is 2700 m²/g. The surface area of a two-layer graphene with no porosity can be calculated as 1350 m²/g. In other embodiments, the surface area of the graphenes results from the combination of the number of stacked sheets and amorphous cavities or pores. In various embodiments, the graphenes have a microporosity ranging from greater than 0% to 50%. e.g., from 20% to 45% or from 20% to 30%, In some embodiments, the graphenes have a BET surface area greater than or equal to 100 m²/g, or less than or equal to 500 m²/g, for example, ranging from 100 to 500 m²/g. The BET surface area can have or include, for example, one of the following ranges: from 100 to 450 m²/g, or from 100 to 400 m or from 100 to 350 m²/g, or from 100 to 300 m²/g, or from 100 to 250 m²/g, or from 100 to 200 m²/g, or from 150 to 500 m²/g, or from 150 to 450 m²/g, or from 150 to 400 m²/g, or from 150 to 350 m²/g, or from 150 to 300 m²/g, or from 150 to 250 m²/g, or from 200 to 500 m²/g, or from 200 to 450 m²/g, or from 200 to 400 m²/g, or from 200 to 350 m²/g, or from 200 to 300 m²/g, or from 250 to 500 m²/g, or from 250 to 450 m²/g, or from 250 to 400 m²/g, or from 250 to 350 m²/g, or from 300 to 500 m²/g, or from 300 to 450 m²/g, or from 300 to 400 m²/g, or from 350 to 500 m²/g, or 350 to 450 m²/g, or from 400 to 500 m²/g. The BET surface area can have or include, for example, one of the following ranges: greater than or equal to 150 m²/g, or greater than or equal to 200 m²/g, or greater than or equal to 250 m²/g, or greater than or equal to 300 m²/g, or greater than or equal to 350 m²/g, or greater than or equal to 400 m²/g, or greater than or equal to 450 m²/g, or less than or equal to 450 m²/g, or less than or equal to 400 m²/g, or less than or equal to 350 m²/g, or less than or equal to 300 m²/g, or less than or equal to 250 m²/g, or less than or equal to 200 m²/g, or less than or equal to 150 m²/g. Other ranges within these ranges are possible.

In embodiments in which the electrode composition includes a blend of carbon black particles and graphenes particles, the BET surface area of the blend of conductive additives can be expressed as a weighted average of BET surface areas of the additives, i.e., [(BET surface area of carbon black particles)*(wt % of carbon black particles)+(BET surface area of graphenes particles)*(wt % of graphenes particles)]. In certain embodiments, the weighted average of BET surface areas of the blend can range from 90 m²/g to 500 m²/g, e.g., 90-280 m²/g.

Graphenes can be produced by various methods, including exfoliation of graphite (mechanically, chemically) as well known in the art. Alternatively, graphenes can be synthesized through the reaction of organic precursors such as methane and alcohols, e.g., by gas phase, plasma processes, and other methods known in the art.

Graphenes are described, for example, in U.S. patent application Publication 2018-0021499, WO 2017/139115; and U.S. Provisional Patent Application No. 62/566,685. Examples of graphenes include the PAS1001 product from Super C; the PBX® 300 G product from Cabot Corporation; HX-GS1 and HX-G8 products from Haoxin; GNC and GNP graphenes available from SUSN; and the xGnP® product from XGSciences.

Turning now to the other components of the compositions, in some embodiments, the expander includes an organic molecule expander. “Organic molecule expander” as defined herein is a molecule capable of adsorbing or covalently bonding to the surface of a lead-containing species to form a porous network that prevents or substantially decreases the rate of formation of a smooth layer of PbSO₄ at the surface of the lead-containing species. In certain embodiments, the organic molecule expander has a molecular weight greater than 300 g/mol. Exemplary organic molecule expanders include lignosulfonates, lignins, wood flour, pulp, humic acid, and wood products, and derivatives or decomposition products thereof. In some embodiments, the expander is selected from lignosulfonates, a molecule having a substantial portion that contains a lignin structure. Lignins are polymeric species having primarily phenyl propane groups with some number of methoxy, phenolic, sulfur (organic and inorganic), and carboxylic acid groups. Typically, lignosulfonates are lignin molecules that have been sulfonated. Typical lignosulfonates include the Borregard Lignotech products UP-393, UP-413, UP-414, UP-416, UP-417, M, D, VS-A (Vanispersc A), Vanisperse-HT, and the like. Other useful exemplary lignosulfonates are listed in, “Lead Acid Batteries”, Pavlov, Elsevier Publishing, 2011, the disclosure of which is incorporated herein by reference.

In various embodiments, the organic molecule expander, e.g., lignosulfonate, is present in an amount ranging from 0.05% to 1.5% by weight, e.g., from 0.2% to 1.5% by weight, or from 0.3% to 1.5% by weight, or from 0.2 to 0.5% by weight, relative to the total weight of the composition (e.g., NAM). The amount of organic molecule expander present can have or include, for example, one of the following ranges: from 0.1 to 1.5 wt %, or from 0.1 to 1 wt %, or from 0.1 to 0.5 wt %, or from 0.2 to 1 wt %, or from 0.1 to 0.5 wt %, or from 0.2 to 0.4 wt %, or from 0.5 to 1.5 wt %, or from 0.5 to 1 wt %, relative to the total weight of the composition. The amount of organic molecule expander present can have or include, for example, one of the following ranges: greater than or equal to 0.05 wt %, or greater than or equal to 0.1 wt %, or greater than or equal to 0.2 wt %, or greater than or equal to 0.5 wt %, or less than or equal to 1.5 wt %, or less than or equal to 1 wt %, or less than or equal to 0.5 wt %.

The lead-containing material is typically selected from lead, PhO, leady oxide, Pb₃O₄, Pb₂O, and PbSO₄, hydroxides, acids, and metal complexes thereof (e.g., lead hydroxides and lead acid complexes). In some embodiments, lead-containing material includes leady oxide. In some embodiments, the compositions include 95 to 99 wt % of lead-containing material, relative to the total weight of the electrode composition. In various embodiments, the compositions (e.g., homogeneous mixtures) further includes BaSO₄, e.g., from 0.7 to 1.2 wt % of BaSO₄, e.g., from 0.8 to 1 wt %, relative to the total weight of the composition.

The compositions can include a range of concentrations for the conductive additives. In embodiments including carbon black particles only, the compositions include 0.1 wt % to 1 wt % of carbon black particles, relative to the total weight of the electrode composition (e.g., NAM). The amount of carbon black particles present can have or include, for example, one of the following ranges: from 0.1 to 0.8 wt %, or from 0.1 to 0.6 wt %, or from 0.1 to 0.4 wt %, or from 0.2 to 1 wt %, or from 0.2 to 0.8 wt %, or from 0.2 to 0.6 wt %, or from 0.4 to 1 wt %, or from 0.4 to 0.8 wt %, or from 0.6 to 1 wt %. The amount of carbon black particles present can have or include, for example, one of the following ranges: greater than or equal to 0.1 wt %, or greater than or equal to 0.2 wt %, or greater than or equal to 0.4 wt %, or greater than or equal to 0.6 wt %, or greater than or equal to 0.8 wt %, or less than or equal to 1 wt %, or less than or equal to 0.8 wt %, or less than or equal to 0.6 wt %, or less than or equal to 0.4 wt %, or less than or equal to 0.2 wt %. In embodiments including a blend of carbon black particles and graphenes, the compositions include 0.25 wt % to 1 wt % of the blend, relative to the total weight of the electrode composition. The amount of the blend present can have or include, for example, one of the following ranges: from 0.25 to 0.75 wt %, or from 0.25 to 0.5 wt %, or from 0.5 to 1 wt %, or from 0.5 to 0.75 wt %, or from 0.75 to 1 wt %. The ratios of the concentrations of graphenes particles to carbon black particles can range from 0.25:1 to 9:1. The ratios of the concentrations of graphenes particles to carbon black particles can have or include, for example, one of the following ranges: from 0.25:1 to 7:1, or from 0.25:1 to 5:1, or from 0.25:1 to 3:1, or from 0.25:1 to 2:1, or from 1:1 to 9:1, or from 1:1 to 7:1, or from 1:1 to 5:1, or from 1:1 to 3:1, or from 1:1 to 2:1, or from 2:1 to 9:1, or from 2:1 to 7:1, or from 1:1 to 5:1, or from 1:1 to 3:1, or from 3:1 to 9:1, or from 3:1 to 7:1, or from 3:1 to 5:1, or from 5:1 to 9:1, or from 5:1 to 7:1, or from 7:1 to 9:1, or from 0.25:1 to 1.25:1, or from 0.25:1 to 1:1, or from 0.25:1 to 0.75:1, or from 0.5:1 to 1.5:1, or from 0.5:1 to 1.25:1, or from 0.5:1 to 1:1, or from 0.75:1 to 1.5:1, or from 0.75:1 to 1.25:1, or from 1:1 to 1.5:1. The ratios of the concentrations of graphemes particles to carbon black particles can have or include, for example, one of the following ranges: greater than or equal to 0.25:1, or greater than or equal to 0.5:1, or greater than or equal to 0.75:1, or greater than or equal to 1:1, or greater than or equal to 1.25:1, or greater than or equal to 2:1, or greater than or equal to 3:1, or greater than or equal to 4:1, or greater than or equal to 5:1, or greater than or equal to 6:1, or greater than or equal to 7:1, or greater than or equal to 8:1, or less than or equal to 9:1, or less than or equal to 8:1, or less than or equal to 7:1, or less than or equal to 6:1, or less than or equal to 5:1, or less than or equal to 4:1, or less than or equal to 3:1, or less than or equal to 2:1, or less than or equal to 1.5:1, or less than or equal to 1.25:1, or less than or equal to 1:1, or less than or equal to 0.75:1, or less than or equal to 0.5:1.

In some embodiments, the electrode compositions are homogeneous aqueous slurries. In other embodiments, the homogeneous compositions are porous solids. For example, drying and curing an aqueous slurry can form a porous solid. In one embodiment, the porous solid and has a surface area of at least 4 m²/g, e.g., at least 5 m²/g.

The compositions can be made by combining the conductive additive(s) with one or more of the components described herein for form a mixture. Sulfuric acid and water are added to the mixture to form a slurry.

In certain embodiments, the slurry (e.g., a paste) is dried. Drying can be achieved by a slow cure, such as under controlled humidity conditions and a moderate amount of heat (e.g., from 30 to 80° C. or from 35 to 60° C.) under controlled humidity, resulting in a porous solid. The curing step can then be followed by a second heating step (drying) at an elevated temperature (e.g., from 50 to 140° C. or from 65 to 95° C.) at extremely low humidity, or even zero humidity. In various embodiments, the composition is a monolith. Other pasting, curing, and formation procedures are described in “Lead Acid Batteries,” Pavlov, Elsevier Publishing, 2011, the disclosure of which is incorporated herein by reference.

In some embodiments, the slurry (e.g., a paste) is deposited (or otherwise pasted) onto a substrate, such as a plate or grid, and allowed to dry on the substrate, where the drying can be performed as disclosed herein. In various embodiments, the plate or grid is a metallic structure that come in a myriad of designs and shapes (e.g., punched or expanded from sheets), functioning as the solid permanent support for the active material. The grid also conducts electricity or electrons to and away from the active material. Grids can include pure metals (e.g., Pb) or alloys thereof. The components of those alloys can comprise Sb, Sn, Ca, Ag, among other metals described in “Lead Acid Batteries, Pavlov, Elsevier Publishing, 2011, the disclosure of which is incorporated herein by reference.

In certain embodiments, the electrode is formed when the cured material that is deposited on the plate is subjected to a charging process, in which lead oxide is reduced to lead metal. For example, this process can include immersing the cured, deposited material in a tank containing an H₂SO₄ solution and charging the material from 120% to 400% of theoretical capacity for a period of time, e.g., at least 2 h, e.g., from 2 h to 25 h.

Disclosed herein are electrode compositions including a homogeneous mixture comprising an electroactive material (e.g., the lead-containing material) and one or more carbon additives described herein. Initially, the mixture is in the form of a paste, e.g., a negative paste. When such a mixture is cured or formed, it is termed a negative active material (NAM). In various embodiment, the NAM has a theoretical NAM BET surface area is greater than or equal to 075 m²/g, or less than or equal to 2 m²/g, e.g., ranging from 075 to 2 m²/g. The theoretical NAM BET surface area can have or include, for example, one of the following ranges: from 0.75 to 1.75 m²/g, or from 0.75 to 1.5 m²/g, or from 0.75 to 1.25 m²/g, or from 0.75 to 1 m²/g, or from 1 to 2 m²/g, or from 1 to 1.75 m²/g, or from 1 to 1.5 m²/g, or from 1 to 1.25 m²/g, or from 1.25 to 2 m²/g, or from 1.25 to 1.75 m²/g, or from 1.25 to 1.5 m²/g, or from 1.5 to 2 m²/g, or from 1.5 to 1.75 m²/g, or from 1.75 to 2 m²/g. The theoretical NAM BET surface area can have or include, for example, one of the following ranges: greater than or equal to 1 m²/g, or greater than or equal to 1.25 m²/g, or greater than or equal to 1.5 m²/g, or greater than or equal to 1.75 m²/g, or less than or equal to 1.75 m²/g, or less than or equal to 1.5 m²/g, or less than or equal to 1.25 m²/g, or less than or equal to 1 m²/g. The theoretical NAM BET surface area of the NAM is determined by formula shown in Example 1 below.

As described in the examples below, in some embodiments, compositions in which the ratio of the theoretical NAM BET surface area to the concentration of the lignosulfonate ((m²/g)/wt %) is greater than or equal to 2 and less than or equal to 4 (e.g., from 2 to 3.5, or 2 to 3, or 2.5 to 4, or 2.5 to 3.5, or from 3 to 4) can provide good low-temperature battery performance. The ratio of the theoretical NAM BET surface area to the concentration of the lignosulfonate ((m²/g)/wt %) can have or include, for example, one of the following ranges: greater than or equal to 2, or greater than or equal to 2.5, or greater than or equal to 3, or greater than or equal to 3.5, or less than or equal to 4, or less than or equal to 3.5, or less than or equal to 3, or less than or equal to 2.5.

Such electrode compositions can be deposited on conducting substrates to form an electrode (e.g., an anode) that can be incorporated in a cell, e.g., a lead-acid battery.

### EXAMPLES

### Example 1

Negative active mass (NAM) formulations: Twenty-Ah flooded lead-acid single cells were prepared with various NAM formulations (n=5), as listed in Table 1. The theoretical NAM surface area is calculated by the following formula:

Carbon BET surface area*Carbon wt. % relative to lead oxide+Lead BET surface*Lead wt. %=Theoretical NAM BET surface area [m²/g]

For example, if a carbon has a BET surface area of 1,000 m²/g and its loading is 1 wt. % (or 0.01 of the total mass), the loading of lead in the NAM is 99% (or 0.99 of the total mass). The surface areas of the lignosulfonate and BaSO₄ are not included as they are small contributors to the NAM surface area. The surface area of Pb in NAM is typically around 0.5 m²/g which leads to theoretical NAM BET surface area of:

1000*0.01+0.5*0.99=10+0.495=10.495 m²/g or approximately 10.5 m²/g

TABLE 1

| | Carbon | | | | |
|---|---|---|---|---|---|
| | BET | | Vanisperse | | Theo- |
| | Surface | | A ligno- | | retical |
| | Area (m²/ | Carbon | sulfonate | BaSO₄ | NAM BET |
| Sample | g) | [%] | [%] | [%] | [m²/g] |
| Control | 70 | 0.25 | 0.3 | 0.8 | 0.5 |
| Carbon A | 394 | 0.25 | 0.3 | 0.8 | 1 |
| Carbon B | 1450 | 0.25 | 0.4 | 0.8 | 3.5 |
| Carbon C | 1083 | 0.5 | 0.4 | 0.8 | 2.5 |
| Carbon D* | 735 | 0.5 | 0.4 | 0.8 | 3.5 |
| Carbon E* | 185 | 0.5 | 0.3 | 0.8 | 0.75 |
| Carbon F | 105 | 0.5 | 0.3 | 0.8 | 1 |

*Carbon D is a blend of activated carbon and carbon black, and Carbon E is a blend of graphenes and carbon black. Their carbon BET surface areas are weighted averages of the applicable individual carbons.

### Example 2

Paste preparation: In a typical NAM paste preparation (Control), 2.5 kg of leady oxide was added into a mixer container and 2.5 g of short fibers (polyethylene terephthalate (PET), Jinkeli) was added into the container. Then, 6.25 g of control carbon black (CB), 20 g of BaSO₄, and 7.5 g of Vanisperse A lignosulfonate were added into the container. The powder was pre-mixed for 5 min. Then, 285 g of deionized water was added into the container over 2 min, and mixed for 5 min. Then, 200 g of 1.4 g/ml H₂SO₄ was added into the container over 10 min, and mixed for 2 min. After mixing, the paste quality was tested by measuring its density and penetration. The paste formulations and their properties are summarized in Table 2. All paste densities were very close, ranging from 4.39 to 4.53 g/cc. There was more variability in paste penetration, with values ranging from 11.51 to 5.54 mm. However, no correlation was found between paste density or penetration and low-temperature performance.

TABLE 2

| | | | | | | | | |
|---|---|---|---|---|---|---|---|---|
| Leady powder | kg | 2.5 | 2.5 | 2.5 | 2.5 | 2.5 | 2.5 | 2.5 |
| BaSO₄ | g | 20 | 20 | 20 | 20 | 20 | 20 | 20 |
| Vanisperse A | g | 7.5 | 7.5 | 10 | 10 | 10 | 7.5 | 7.5 |
| lignosulfonate | | | | | | | | |
| Control | g | 6.25 | | | | | | |
| Carbon A | g | | 6.25 | | | | | |
| Carbon B | g | | | 6.25 | | | | |
| Carbon C | g | | | | 12.5 | | | |
| Carbon D | 8 | | | | | 12.5 | | |
| Carbon E | g | | | | | | 12.5 | |
| Carbon F | g | | | | | | | 12.5 |
| Short fiber | g | 2.5 | 2.5 | 2.5 | 2.5 | 2.5 | 2.5 | 2.5 |
| Water | g | 285 | 285 | 285 | 285 | 285 | 285 | 285 |
| Sulfuric acid | g | 200 | 200 | 200 | 200 | 200 | 200 | 200 |
| (1.4 g/cc) | | | | | | | | |
| Total | g | 33.75 | 33.75 | 36.25 | 42.5 | 42.5 | 40 | 40 |
| Additives | | | | | | | | |
| Penetration | 1 | 10.95 | 7.81 | 6.08 | 8.82 | 10.6 | 6.38 | 7.21 |
| (mm) | 2 | 11.23 | 7.37 | 7.43 | 7.99 | 11.61 | 5.25 | 7.18 |
| | 3 | 12.34 | 7.69 | 5.61 | 8.06 | 10.67 | 4.98 | 6.76 |
| | average | 11.51 | 7.62 | 6.37 | 8.29 | 10.96 | 5.54 | 7.05 |
| Total weight | g | 952.34 | 962 | 957.78 | 954.96 | 951.3 | 963.4 | 959.41 |
| Density | g/cm³ | 4.40 | 4.48 | 4.44 | 4.42 | 4.39 | 4.49 | 4.46 |

### Example 3

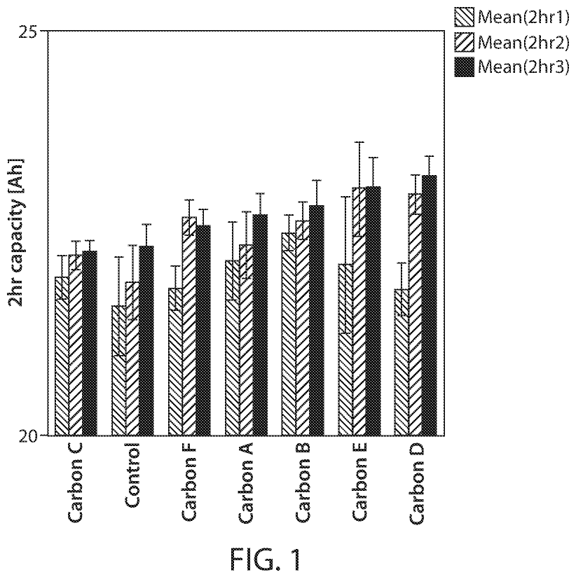

Electrode two-hour rate capacity: Cells were fully charged and discharged to 1.75V at a two-hour rate (10 A current), three times at ambient temperature (20° C.). All cells display capacity above their rated capacity of 20-Ahr. The results are shown in FIG. 1, which shows that Carbons D and E had the highest cycle capacity when measured the second and third time.

### Example 4

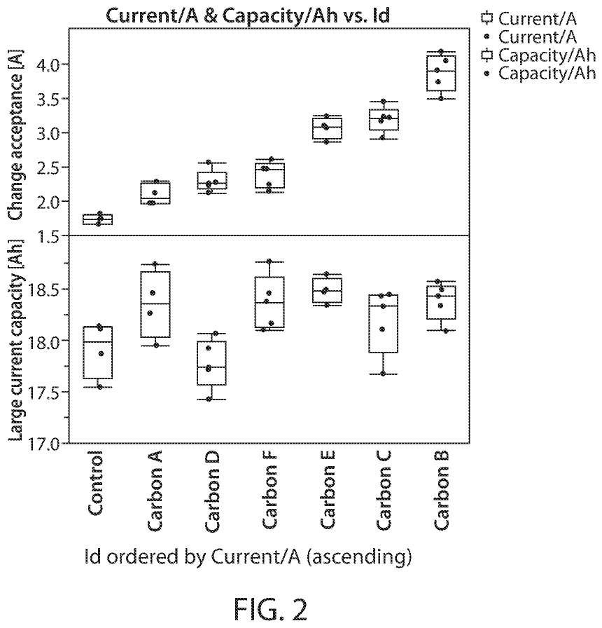

High current discharge capacity and charge acceptance: The high current discharge capability of the cells was tested at ambient temperature (20° C.) using 3.6*i (2 hr) current. The static charge acceptance of the cells was measured as the static current after 10 min charging at 2.47V. Referring to FIG. 2, the best charge acceptance was achieved with highest BET surface area Carbons B and C. However, high current discharge capability was also observed with lower BET surface area Carbons A and F, as well as for Carbon E, a blend of graphenes and carbon black. All the carbons tested had large current capacity that were similar or better than Control, and charge acceptance significantly higher than Control. These results indicate that these formulations may also perform well at low temperatures, and that large carbon surface area may not be needed for low-temperature performance.

### Example 5

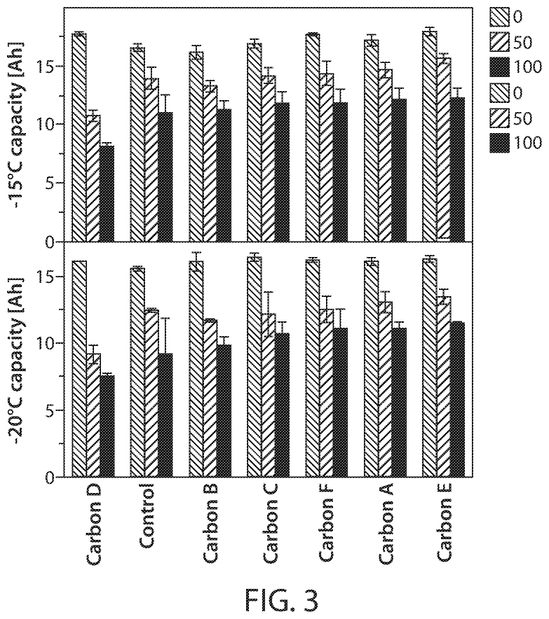

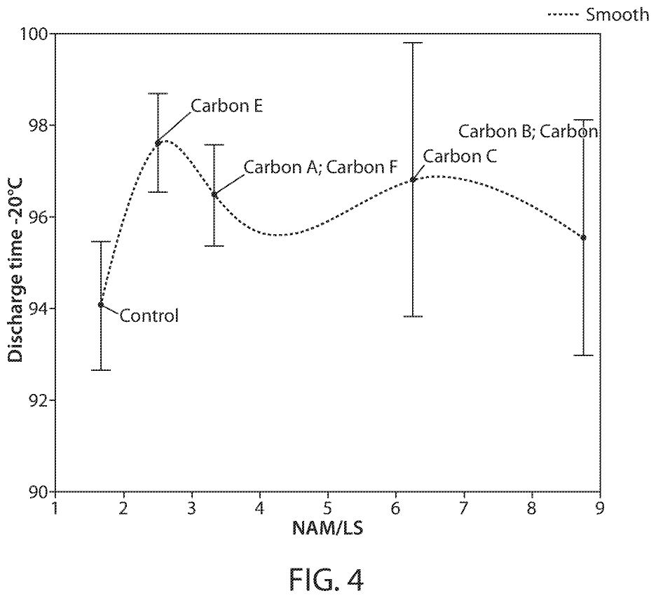

Low temperature capacity: Cells were fully charged at ambient temperature (20° C.) and discharged to 1.75V at 2 hr. rate (10 A current), at temperatures of −15° C. and −20° C. This process was performed initially, after 50 cycles and after 100 cycles. Referring to FIG. 3, Carbons A, E, and F had the highest low-temperature capacity, and best low-temperature capacity retention after 100 cycles. These carbons had theoretical NAM BET surface areas ranging from between 0.75 and 1 m²/g. It is believed that lignosulfonate content in the electrode is also important to achieve low-temperature performance and should be adjusted to the NAM of the electrode. In all the formulations tested, the optimal NAM/lignosulfonate loading ratio (m²/g)/(wt. % lignosulfonate) was found to range from between 2 to 4, e.g., 2.5-3.5 (FIG. 4).

### Example 6

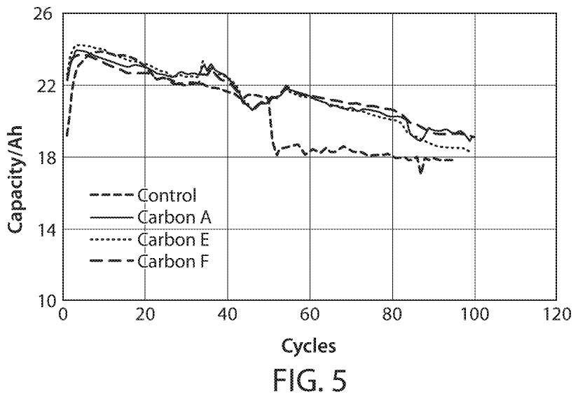

Cycle-life testing: Cycle-life tests were performed on Control and Carbons A, E, and F with 4 h charging at 2.47V and 100% depth-of-discharge (DOD) at C/2 to 1.75V. As indicated previously, low-temperature capacity of the cells was checked initially, after 50 cycles, and after 100 cycles. Referring to FIG. 5, compared to Control, within the first 50 cycles, the cells with three best low-temperature formulations (Carbons A, E, and have similar cycling capacity. From cycles 50 to 100, cells with Carbons A, E, and F had higher discharge capacity than Control.

The use of the terms “a” and “an” and “the” is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All publications, applications, ASTM standards, and patents referred to herein are incorporated by reference in their entirety.

Still other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A composition suitable for a negative plate of lead-acid battery, the composition comprising:
a lead-based active material;
at least one material selected from the group consisting of a lignosulfonate and barium sulfate; and
carbon black particles having a Brunauer-Emmett-Teller (BET) surface area greater than or equal to 90 m²/g and less than or equal to 900 m²/g, and an oil adsorption number (OAN) greater than or equal to 150 mL/100 g and less than or equal to 300 mL/100 g,
wherein the composition has a theoretical negative active mass (NAM) BET surface area greater than or equal to 0.75 m²/g and less than or equal to 2 m²/g.

2. The composition of claim 1, wherein the carbon black particles have an OAN greater than or equal to 170 mL/100 g and less than or equal to 250 mL/100 g.

3. The composition of claim 1, wherein the composition has a theoretical NAM BET surface area greater than or equal to 0.75 m²/g and less than or equal to 1 m²/g.

4. (canceled)

5. (canceled)

6. The composition of claim 1, comprising greater than or equal to 0.7 wt % and less than or equal to 1.2 wt % of the barium sulfate.

7. The composition of claim 1, comprising greater than or equal to 0.1 wt % and less than or equal to 1 wt % of the carbon black particles.

8. (canceled)

9. The composition of claim 1, wherein the carbon black particles have surface energy ranging from 10 to 30 mJ/m².

10. The composition of claim 1, wherein the carbon black particles have a Lₐ crystallite size ranging from 10 to 25 Angstroms.

11. The composition of claim 1, wherein the carbon black particles have a L_{c} crystallite size ranging from 10 to 20 Angstroms.

12. The composition of claim 1, wherein the carbon black particles have % crystallinity (I_{G}/(I_{G}+I_{D}))×100%) ranging from 20 to 35%.

13. The composition of claim 1, wherein the carbon black particles have a statistical thickness surface area ranging from 80 to 180 m²/g.

14. (canceled)

15. (canceled)

16. A composition suitable for a negative plate of lead-acid battery, the composition comprising:
a lead-based active material;
at least one material selected from the group consisting of a lignosulfonate and barium sulfate;
carbon black particles having a Brunauer-Emmett-Teller (BET) surface area greater than or equal to 40 m²/g and less than or equal to 500 m²/g; and
graphenes particles,
wherein the composition has a theoretical negative active mass (NAM) BET surface area greater than or equal to 0.75 m²/g and less than or equal to 2 m²/g.

17. The composition of claim 16, wherein the carbon black particles have an OAN greater than or equal to 75 mL/100 g and less than or equal to 300 mL/100 g.

18. The composition of claim 16, wherein the composition has a theoretical NAM BET surface area greater than or equal to 0.75 m²/g and less than or equal to 1 m²/g.

19. The composition of claim 16, comprising greater than or equal to 0.1 wt % and less than or equal to 0.5 wt % of the lignosulfonate.

20. (canceled)

21. The composition of claim 16, comprising greater than or equal to 0.7 wt % and less than or equal to 1.2 wt % of the barium sulfate.

22. The composition of claim 16, comprising greater than or equal to 0.1 wt % and less than or equal to 1 wt % of the carbon black particles.

23. (canceled)

24. The composition of claim 16, wherein the graphenes particles have a BET surface area greater than or equal to 100 m²/g and less than or equal to 500 m²/g.

25. The composition of claim 16, wherein the ratio of the concentrations of the graphenes particles to carbon black particles range from 0.25:1 to 1.5:1.

26. The composition of claim 16, wherein the total concentration of the carbon black particles and the graphenes particles is greater than or equal to 0.25 wt % and less than or equal to 1 wt %.

27-34. (canceled)
